(19) United States
(12) Patent Application Publication
(10) Pub. No.: US 2026/0284475 A1
(43) Pub. Date: Sep. 24, 2026

(54) SYSTEM AND METHOD FOR MONITORING ATHLETIC PERFORMANCE

(71) Applicant: Christopher Daily, Melbourne, FL (US)

(72) Inventor: Christopher Daily, Melbourne, FL (US)

(21) Appl. No.: 19/354,513

(22) Filed: Oct. 9, 2025

Related U.S. Application Data
(60) Provisional application No. 63/775,048, filed on Mar. 20, 2025.

(51) Int. Cl. A63B 24/00; A63B 71/06; G07F 17/32

(52) U.S. Cl. CPC A63B 24/0006; A63B 71/0622; G07F 17/3288; A63B 2024/0012; A63B 2220/833; A63B 2220/836

(57) ABSTRACT

A system for performance monitoring comprises a monitor system, an equipment system, and a control system. The monitor system is worn by a wearer and monitors characteristics associated with the wearer to define sensed monitor characteristics. The equipment system is carried by an equipment item and monitors characteristics associated with the equipment item to define sensed equipment characteristics. The control system comprises a control computation unit in communication with both systems and includes an accessible datastore. The monitor system generates a monitor signal associated with the sensed monitor characteristics. The equipment system generates an equipment signal associated with the sensed equipment characteristics. The control computation unit performs a determination process based on the monitor and equipment signals to generate action sets.

### RELATED APPLICATIONS

This application claims priority under 35 U.S.C. § 119(e) of U.S. Provisional Patent Application Ser. No. 63/775,048 (Attorney Docket No. 9151.00001) filed on Mar. 20, 2025, and titled SYSTEM AND METHOD FOR MONITORING ATHLETIC PERFORMANCE, the contents of which are incorporated herein by reference except to the extent that content there conflicts with content herein.

### FIELD OF THE INVENTION

The present invention relates to systems and methods for monitoring the physical performance of one or more persons.

### BACKGROUND OF THE INVENTION

Current methodologies for analyzing athletic performance, such as in the context of the mechanics of frequently performed actions during a particular sporting events, have been continually advanced upon. Such as those described by Klay & Splash (2024) which offers tracking of basic movement patterns. However, current approaches fail to provide for an integrated system for such methodologies and solutions that could yield further advantageously precise and actionable insights into human motion and mechanics.

Existing technologies often fail to account for the complex interrelationships between biomechanical positioning, force application, and timing—factors that can be critical to achieving greater athletic performance. For example, the basketball jump shot, while appearing straightforward to observers, involves intricate biomechanical sequences. Despite this, current analytical frameworks do not adequately model these sequences with the amount of precision required to be noteworthy or actionable.

Moreover, current analysis methodologies fail to provide for a trustworthy source of information and guidance that could enhance understanding of movement initiation, trajectory optimization, and performance consistency. This gap in the prior art leaves unaddressed the need for a more precise, useful, and effective approach to motion tracking and analysis of athletic actions and performance and fail to provide reliable guidance therefor.

In the realm of sports, sustained success is often undermined by periods of complacency, particularly when fundamental elements are neglected or ignored. Current systems do not provide systematic safeguards against such complacency, nor do they offer mechanisms for maintaining high levels of kinesthetic awareness, such as, during extended periods of performance. This deficiency is particularly evident in athlete development programs, where data-driven feedback is often too generalized to support nuanced improvements in technique and consistency.

There remains a need for a system and/or method that can translate complex biomechanical data into intuitive, reliable, and actionable feedback that can be used to further aid athletic pursuits of practical mastery. Current technologies do not adequately address this need, nor do they provide reliable real-time assessments of movement efficiency, stability, and optimization potential.

The prior art further fail to provide a solution that utilizes reliable athletic performance for improving upon other matters that may not be directly related to the athletic actions or performance itself, such as, and not limited to, performance of wagers, bets, and/or gambling.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, embodiments of the present invention may be related to a system for performance monitoring. The system may comprise a monitor system, an equipment system, and a control system. The monitor system may be configured to be worn by a wearer. The monitor system may be operable to monitor and sense one or more monitor characteristics. The one or more monitor characteristics may be associated with the wearer. The one or more monitor characteristics monitored and sensed by the monitor system may define one or more sensed monitor characteristics. The equipment system may be carried by an equipment item. The equipment system may be operable to monitor and sense one or more equipment characteristics. The one or more equipment characteristics may be associated with the equipment item. The one or more equipment characteristics monitored and sensed by the equipment system may define one or more sensed equipment characteristics. The control system may comprise a control computation unit. The control computation unit may be positioned in communication with the monitor system and the equipment system. The control system may include a datastore. The datastore may be accessible by the control computation unit.

The monitor system may be operable to generate and emit a monitor signal. The monitor signal may be associated with the sensed one or more monitor characteristics. The equipment system may be operable to generate and emit an equipment signal. The equipment signal may be associated with the sensed one or more equipment characteristics. The control computation unit may be operable to perform a determination process. The determination process may be based on one or more of the monitor signal and the equipment signal. The determination process may generate one or more action sets.

The control computation unit may be further operable to generate a report output. The report output may be based on the one or more action sets. The control computation unit may be operable to store the report output. The control computation unit may be operable to send the report output to be displayed on a display. The display may be in communication with the control computation unit. Reference data may be stored on the datastore. The determination process may be performed based on one or more of the monitor signal, the equipment signal, and the reference data.

The system may further comprise an interface. The interface may be in communication with the control computation unit. The interface may be operable to provide an input signal. The input signal may be responsive to a user input. The input signal may comprise input reference data. The control computation unit may be operable to define at least a portion of the reference data. The at least a portion of the reference data may be based on the input reference data.

A library of action sets may be stored on the datastore. The control computation unit may be operable to generate a comparison output. The comparison output may be generated by comparing the one or more action sets with one or more portions of the library of action sets. The control computation unit may be operable to store the comparison output. The control computation unit may be operable to send the comparison output to be displayed on a display. The display may be in communication with the control computation unit.

The control computation unit may be operable to generate one or more metric quantifications. The one or more metric quantifications may be based on one or more of the monitor signal, the equipment signal, and the one or more action sets. The control computation unit may be operable to generate one or more coaching points. The one or more coaching points may be based on the one or more metric quantifications. The control computation unit may be operable to send the one or more coaching points to be displayed on a display. The display may be in communication with the control computation unit. The one or more coaching points may include a prompt. The prompt may be associated with one or more of a direction, a point of information, a tip, advice, a task, a change, and an improvement. The prompt may be related to the one or more action sets. The prompt may include a request for input. The request for input may acknowledge the prompt and the one or more coaching points.

The system may further comprise an auxiliary sensor system. The auxiliary sensor system may be in communication with the control computation unit. The auxiliary sensor system may be operable to track and sense one or more auxiliary characteristics. The one or more auxiliary characteristics may be associated with one or more of the equipment item and the wearer. The one or more auxiliary characteristics may be defined as one or more sensed auxiliary characteristics. The auxiliary sensor system may be operable to generate and send an auxiliary signal to the control computation unit. The auxiliary signal may be based on the one or more sensed auxiliary characteristics. The determination process may be performed based on one or more of the equipment signal, the monitor signal, and the auxiliary signal.

The control computation unit may be operable to generate an outcome prediction analysis. The outcome prediction analysis may be based on one or more of the one or more action sets, the monitor signal, and the equipment signal. The control computation unit may be further operable to communicate with a third-party server. The third-party server may comprise a sports betting service. The sports betting service may host sports betting activities. The control computation unit may be operable to generate and send a betting signal to the third-party server. The betting signal may be based on the outcome prediction analysis. The betting signal may cause the third-party server to generate an additional sport betting activity or change one or more of the sports betting activities.

The control computation unit may be operable to receive an input signal from an interface. The betting signal may be further based on the input signal. The input signal may comprise one or more of a bankroll management rule, an injury report, a hedging threshold, a loss mitigation rule, a multi-position rule, an exit point rule, a cash out timing rule, a closing line value rule, a risk exposure limit rule, a position adjustment rule, and a loss limit rule. Historical data may be stored on the datastore. The control computation unit may be operable to generate the outcome prediction analysis. The outcome prediction analysis may be based on the one or more action sets, the monitor signal, the equipment signal, and the historical data.

A method aspect of an embodiment of the present invention may be directed to a method for performance monitoring. The method may comprise providing a control system. The control system may comprise a control computation unit. The method may include sensing one or more monitor characteristics. The one or more monitor characteristics may be associated with a wearer. The sensing may be performed with a monitor system. The monitor system may be carried by the wearer. The sensing may define one or more sensed monitor characteristics. The method may include sensing one or more equipment characteristics. The one or more equipment characteristics may be associated with an equipment item. The sensing may be performed with an equipment system. The equipment system may be carried by the equipment item. The sensing may define one or more sensed equipment characteristics.

The method may include generating and emitting a monitor signal. The monitor signal may be associated with the sensed one or more monitor characteristics. The method may include generating and emitting an equipment signal. The equipment signal may be associated with the sensed one or more equipment characteristics. The method may further include accessing reference data. The reference data may be stored on a datastore. The accessing may be performed with the control computation unit. The method may include performing a determination process. The determination process may be based on one or more of the monitor signal, the equipment signal, and the reference data. The determination process may generate one or more action sets.

The method may further comprise determining one or more metric quantifications. The one or more metric quantifications may be determined based on one or more of the monitor signal, the equipment signal, the reference data, and the one or more action sets. The method may include generating one or more coaching points. The one or more coaching points may be based on the one or more metric quantifications. The method may include displaying the one or more coaching points on a display. The display may be in communication with the control computation unit. The one or more coaching points may include a prompt. The prompt may be associated with the one or more action sets. The prompt may comprise one or more of a direction, a point of information, a tip, advice, a task, a change, and an improvement.

The method may further comprise performing and generating an outcome prediction analysis. The outcome prediction analysis may be based on one or more of the equipment signal, the monitor signal, the reference data, and the one or more action sets. The method may include generating and sending a betting signal to a third-party server. The betting signal may be based on the outcome prediction analysis. The betting signal may cause the third-party server to generate a sport betting activity or change one or more of a plurality of sports betting activities.

### BRIEF DESCRIPTION OF THE DRAWINGS

Some embodiments of the present invention are illustrated as an example and are not limited by the figures of the accompanying drawings, in which like references may indicate similar elements.

FIG. 1 is a schematic diagram of a system for performance monitoring according to an embodiment of the present invention.

FIG. 2 is a schematic diagram of an equipment system of the system for performance monitoring according to FIG. 1.

FIGS. 3-6 are flowcharts illustrating various method aspects according to embodiments of the present invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

An embodiment of the invention, as shown and described by the various figures and accompanying text, provides a system 100 for performance monitoring for sensing, recording, monitoring, and/or analyzing the performance and/or athletic performance of one or more persons, such as, and without limitation, persons whom are athletes, persons planning to be an athlete, persons who play in sports events, and/or persons who plan to play in a sports event, and/or any other persons who desire or are desired to have his or her athletic performance recorded, monitored, and/or analyzed. It should be understood that throughout this description, references to the “control system 140” and the “control computation unit 141” may be used interchangeably without limitation. For instance, without limitation, when the describing that the control system 140 is operable to perform some function or include some feature, it should be understood that also the control computation unit 141 is operable to perform that same function or includes that same feature as well, and vice versa.

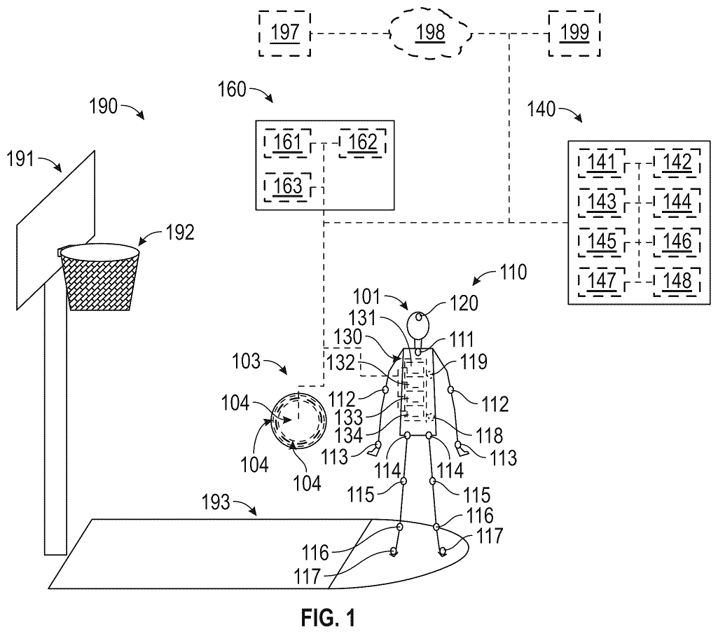

Initially referring to FIG. 1, the system 100 for performance monitoring may include a control system 140, an equipment system 104, and a monitor system 110. The control system 140 may be in communication with the equipment system 104 and/or with the monitor system 110. The equipment system 104 may be carried by an equipment item 103. The equipment item 103 may comprise a sports item to be interacted with by a user during a sporting event and/or during a sport activity such as, without limitation, during basketball, baseball, softball, football, soccer, hockey, and/or tennis and/or any other sport event or activity as may be understood by those who may have skill in the art.

Examples of the equipment item 103 include, without limitation, a basketball, a golf club, a golf ball, a baseball, a baseball bat, a soccer ball, a frisbee, gloves, a helmet, a tennis racket, a tennis ball, a bowling ball, a dart, a discus, a snowboard, snow skis, a wakeboard, a waterski, a surfboard, a volleyball, knee pads, a shuttlecock, a badminton racket, a cricket ball, a cricket bat, stumps, pads, a hockey stick, a hockey puck, a field hokey ball, a rugby ball, a scrum cap, a football, shoulder pads, a lacrosse stick, a lacrosse ball, a table tennis paddle, a table tennis ball, a bow, arrows, a target, boxing gloves, a punching bag, a bicycle, a foil, an epee, a saber, a mask, skates, a kayak, a paddle, a rowing boat, oars, a skateboard, a softball, a squash racket, a squash ball, a javelin, a shot put, hurdles, a barbell, weights, a curling stone, a ski pole, and/or a shotput. In some embodiments of the present invention, the equipment system 104 may be installable in an equipment item 103. Furthermore, in some embodiments of the present invention, the equipment system 104 may be integrated into an equipment item 103.

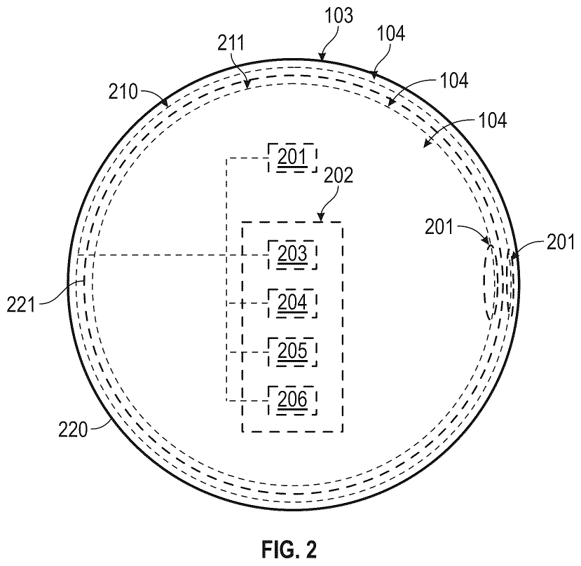

Now referring to FIGS. 1 and 2, the equipment system 104 may be carried by the equipment item 103 by a portion of the equipment system 104 being mounted on and/or within an outer surface 220 of the equipment item 103. In some embodiments of the present invention, a portion of the equipment system 104 may be embedded within the equipment item 103 between the outer surface 220 and an inner surface 221 of the equipment item 103, which may be defined as an embedment layer 210. In some embodiments of the present invention, a portion of the equipment system 104 may be mounted on the inner surface 221 of the equipment item 103, which may be defined as an inner surface layer 211. Furthermore, in some embodiments of the present invention, a portion of the equipment system 104 may be housed within the equipment item 103.

The equipment system 104 may include one or more of an equipment sensor 201 and/or an equipment control system 202. The equipment sensor(s) 201 may be operable to identify, detect, determine, monitor, and/or sense at least one equipment characteristic which may be associated with and/or related to the equipment item 103. For example, without limitation, the equipment sensor(s) 201 may comprise one or more of a strain gauge, a force sensor, a grip sensor, a touch sensor, an accelerometer, an altimeter, an orientation sensor, and inertia sensor, a GPS sensor, a magnetometer, a temperature sensor, a pressure sensor, a speed sensor, a magnetic field sensor, and/or a vector sensor.

The equipment sensors 201 may generate and/or provide an equipment signal that may be related to at least one equipment characteristic that may be associated with the equipment item 103. The equipment characteristic may include, without limitation, one or more of a strain detection, a hand placement detection, a force detection, a grip detection, a touch detection, an acceleration detection, an altitude detection, an orientation detection, an inertia detection, a position detection, a temperature detection, a pressure detection, a speed detection, and/or a vector detection.

The equipment sensor(s) 201 may be carried by the equipment item 103, and a portion of the equipment sensor 201 may be being mounted on and/or within the outer surface 220 of the equipment item 103. In some embodiments of the present invention, at least a portion of the equipment sensor(s) 201 may be embedded within the equipment item 103 between the outer surface 220 and the inner surface 221 of the equipment item 103, which may be referred to as the equipment sensor(s) 201 being embedded within the embedment layer 210 of the equipment item 103. In some embodiments of the present invention, at least a portion of the equipment sensor(s) 201 may be mounted on the inner surface 221 and/or inner surface layer 211 of the equipment item 103. Furthermore, in some embodiments of the present invention, one or more of the equipment sensor(s) 201 may be housed within the equipment item 103.

In some embodiments of the present invention, the equipment item 103 may comprise a plurality and/or a pair of equipment items 103. In embodiments that use more than one equipment item 103, each equipment item 103 may carry its own respective equipment system 104, and/or each equipment item 103 may carry one or more of its own respective equipment sensor(s) 201. For example, without limitation, the plurality of equipment items 103 may comprise a tennis ball and a tennis racket, a hockey stick and a hockey puck, a baseball, and a baseball bat, and/or a lacrosse ball and a lacrosse stick.

The equipment control system 202 may include one or more of an equipment computation unit 203, an equipment memory unit 206, an equipment communication unit 205, and/or an equipment power unit 204. The equipment computation unit 203 may be in communication with one or more of the equipment memory unit 206, the equipment communication unit 205, and/or the equipment power unit 204. The equipment power unit 204 may also be in communication with the equipment communication unit 205 and/or the equipment memory unit 206. The equipment power unit 204 may store, regulate, manage, and/or provide power to one or more of the equipment computation unit 203, the equipment memory unit 206, and the equipment communication unit 205.

The equipment control system 202, the equipment computation unit 203, and/or the equipment communication unit 205 may be operable to receive the equipment signal from the equipment sensor(s) 201. The equipment computation unit 203 may receive the equipment signal from the equipment sensor(s) 201 via the equipment communication unit 205. The equipment control system 202 may be operable to store the equipment signal. The equipment computation unit 203 may be operable to store the equipment signal in the equipment memory unit 206.

The monitor system 110 may include one or more of a monitor sensor 111-120 and/or a monitor control system 130. The monitor system 110, the monitor sensor(s) 111-120, and/or the monitor control system 130 may be configured to be worn by a user / wearer 101 and/or to be removably carried by a user/wearer 101. Throughout the description of the present invention herein, without limitation, a user that may be wearing and/or removably carrying at least a portion of the monitor system 110, may be alternative and/or interchangeably referred to as a wearer 101. The monitor sensors 111-120 may be worn and/or removably carried by a wearer 101 at and/or on various locations of the wearer's 101 body and/or at and/or on one or more of the extremities of the wearer 101.

For example, without limitation, the monitor sensor(s) 111-120 may include one or more of a shoulder sensor 111, an elbow sensor 112, a wrist sensor 123, a hip sensor 114, a knee sensor 115, an ankle sensor 116, a foot sensor 117, an abdominal sensor 118, a chest sensor 119, and/or a head sensor 120. Those skilled in the art will appreciate that the monitor sensors 111-120 may be individually worn and/or carried by the wearer's 101 body or may be carried by a suit or other article of clothing that can be worn by the user so that positioning of the sensors 111-120 on the suit correlates to the position on the wearer's 101 body that is desired to be sensed.

Alternatively, those skilled in the art will appreciate that some portion of the sensors 111-120 may be carried together on a first article to be worn by the wearer and remaining portions of the sensors 111-120 may be carried by another article to be worn by the wearer. For example, a plurality of the sensors 111-120 may be carried by a shirt type of article, while another plurality of sensors 111-120 may be carried by a pants type of article, while still another plurality of sensors 111-120 may be carried by a helmet/hat type of article. The combination of articles that can be configured to carry the sensors 111-120 according to embodiments of the present invention are numerous.

The monitor sensor(s) 111-120 may be operable to identify, detect, determine, monitor, and/or sense at least one monitor characteristic that may be associated with the wearer and/or that may be associated with an extremity of the wearer 101. Examples of the monitor sensor(s) 111-120 may include, without limitation, one or more of a force sensor, an acceleration sensor, an altitude sensor, an orientation sensor, an inertia sensor, a position sensor, a speed sensor, and a vector sensor. The monitor characteristic may include, without limitation, one or more of a force detection, a temperature detection, an acceleration detection, an altitude detection, an orientation detection, an inertia detection, a position detection, a speed detection, and/or a vector detection. The monitor sensor(s) 111-120 may be operable to generate and/or emit a monitor signal that may be associated with at least one monitor characteristic.

The monitor control system 130 may include one or more of a monitor computation unit 131, a monitor memory unit 134, a monitor communication unit 133, and/or a monitor power unit 132. The monitor memory unit 134 may be in communication with the monitor computation unit 131. The monitor communication unit 133 may be in communication with the monitor computation unit 131. The monitor power unit 132 may be in communication with one or more of the monitor computation unit 131, the monitor memory unit 134, and/or the monitor communication unit 133 to store, regulate, manage, and/or provide power thereto.

The monitor control system 130, the monitor computation unit 131, and/or the monitor communication unit 133 may be operable to receive the monitor signal from the monitor sensor(s) 111-120. The monitor computation unit 131 may be operable to receive the monitor signal from the at least one monitor sensor(s) 111-120 via the monitor communication unit 133. The monitor control system 130 may be operable to store or monitor signal. The monitor computation unit 131 may be operable to store the monitor signal in the monitor memory unit 134.

In some embodiments of the present invention, the monitor computation unit 131, the monitor memory unit 134, the monitor communication unit 133, and/or the monitor power unit 132 may be carried and/or housed by and/or with one or more of the monitor sensor(s) 111-120. For example, without limitation, the monitor computation unit 131, the monitor memory unit 134, the monitor communication unit 133, and/or the monitor power unit 132 may be carried and/or housed by and/or with one or more of the monitor sensor(s) 111-120 within and/or by a shared housing adapted to be worn and/or carried by a wearer 101. The shared housing may include, without limitation, one or more of a removable attachment band, a removable attachment strap, a removable adhesive, a removable suction attachment, and/or a removeable hook-and-loop attachment. In some other embodiments of the present invention, the monitor computation unit 131, the monitor memory unit 134, the monitor communication unit 133, and/or the monitor power unit 132 may be carried by a clothing item which may be worn and/or carried by a wearer 101. Examples of the clothing item include, without limitation, a jacket, a vest, a shirt, a sweater, pants, shorts, and a backpack.

The control system 140 may include one or more of a control computation unit 141, a control memory unit 142, a datastore 143, a control power unit 144, a control communication unit 145, and/or a bus unit 146. In some embodiments of the present invention, the control system 140 may include and/or may be in communication with one or more of an interface 147 and/or a display 148. The control memory unit 142 may be in communication with one or more of the control computation unit 141, the datastore 143, the control power unit 144, and/or the bus unit 146. The datastore may be in communication with one or more of the control computation unit 141, the control memory unit 142, the control power unit 144, and/or the bus unit 146.

The interface 147 may be in communication with one or more of the control computation unit 141, the control power unit 144, the bus unit 146, the control communication unit 145, and/or the display 148. The display may be in communication with one or more of the control computation unit 141, the control power unit 144, the bus unit 146, and/or the control communication unit 145. The control communication unit 145 may be in communication with one or more of the control computation unit 141, the control power unit 144, the bus unit 146, the equipment computation unit 203, the monitor computation unit 131, the equipment communication unit 205, and/or the monitor communication unit 133.

The control communication unit 145 may allow, provide, and/or facilitate communication between the control computation unit 141 and the equipment computation unit 203, the monitor computation unit 131, the equipment communication unit 205, and/or the monitor communication unit 133. The control power unit 144 may be operable to store, monitor, regulate, supply, and/or provide power to one or more of the control computation unit 141, the control memory unit 142, the datastore 143, the control communication unit 145, and/or the bus unit 146. The control power unit 144 may provide power to the interface 147 and/or to the display 148.

Examples of the equipment computation unit 203, the monitor computation unit 131, and/or the control computation unit 141 include, without limitation, a processor, a co-processor, a post-processor, a graphics processor, a controller, a microcontroller, a field-programmable gate array (FPGA), and/or an application specific integrated circuit (ASIC) and/or any combination(s) thereof, and/or any other computation device as may be understood by those who may have skill in the art. Examples of the equipment communication unit 205, the monitor communication unit 133, and/or the control communication unit 145 include, without limitation, one or more of a network card, a switch, a router, a wired communication device, a wireless communication device, a network hub, a modem and/or any combination(s) thereof and/or any other machine networking device as may be understood by those who may have skill in the art.

Examples of the equipment memory unit 206, the monitor memory unit 134, and/or the control memory unit 142 include, without limitation, one or more of a volatile machine-readable data memory, a non-volatile machine-readable data memory, a random-access memory (RAM), a non-random-access memory (nRAM), virtual random access memory (VRAM), flash memory, solid state memory, and/or any combination(s) and/or any other machine-readable memory as may be understood by those who may have skill in the art. Examples of the datastore 143 include, without limitation, one or more of volatile machine-readable data storage, a non-volatile machine-readable data storage, a hard drive, flash data storage, a solid state drive, cloud-based data storage, server-based data storage, compact disk data storage, and/or any combination(s) thereof and/or any other machine-readable data storage device as may be understood by those who may have skill in the art.

Examples of the bus unit 146 include, without limitation, one or more of a motherboard, breakout board, and/or printed circuit board and/or any combination(s) thereof and/or any other bus communication and/or operation facilitation device as may be understood by those who may have skill in the art. Examples of the interface 147 include, without limitation, one or more of a button, a touch screen display, a track pad, a mouse, a keyboard, and/or a switch and/or any combination(s) thereof and/or any other input device as may be understood by those who may have skill in the art. Examples of the display 148 include, without limitation, one or more of a television device, a monitor display, a laptop display, a smartphone display, a touchscreen display, a smart-television, a tablet device display and/or any combination(s) thereof and any other display device as may be understood by those who may have skill in the art.

The control system 140, the control computation unit 141, and/or the control communication unit 145 may be operable to receive the equipment signals and/or the monitor signals. The control computation unit 141 may be operable to receive the equipment signal and/or the monitor signal via the control communication unit 145. The control system 140 may be operable to store the monitor signal and/or the equipment signal. The control computation unit 141 may be operable to store the equipment signal and/or the monitor signal in the control memory unit 142 and/or in the datastore 143. In some embodiments of the present invention, the datastore 143 may store reference data. The control computation unit 141 may be operable to access the datastore 143 to access the reference data.

The reference data may include, without limitation, one or more of selected player characteristics, selected player parameters, predetermined player characteristics, predetermined player parameters, a listing of player characteristic histories, selected tracking parameters, predetermined tracking parameters, selected phase parameters, predetermined phase parameters, a selected baseline parameter, a predetermined baseline parameter, a selected target action set, a predetermined target action set, a selected target equipment action, a predetermined target equipment action, a selected target wearer action, a predetermined target wearer action, a selected sport type, a predetermined sport type, a selected equipment item type, a predetermined equipment item type, a selected target improvement goal, a predetermined target improvement goal, a reference player selection, a predetermined reference player, a selected target outcome, and/or a predetermined target outcome and/or any combination(s) thereof.

The interface 147 may be operable to provide an input signal to the control computation unit 141 based on a user input made at the interface 147. The input signal may comprise a command and/or input reference data. The control computation unit 141 may be responsive to the command to perform one or more predetermined actions. The predetermined actions may include, without limitation, one or more of causing the control computation unit 141 to perform, make, and/or provide one or more of the determinations and/or outputs described herein, and/or commanding or controlling one or more of the equipment system 104, monitor system 110, an auxiliary sensor system 160, and/or the display 148 to perform one or more of their features and/or actions described herein.

The input reference data may comprise one or more of the same and/or similar portion(s) of data as described herein with regards to the reference data. For example, without limitation, the input reference data may include one or more of selected player characteristics input, selected player parameters input, predetermined player characteristics input, predetermined player parameters input, a listing input of player characteristic histories, selected tracking parameters input, predetermined tracking parameters input, selected phase parameters input, predetermined phase parameters input, a selected baseline parameter input, a predetermined baseline parameter input, a selected target action set input, a predetermined target action set input, a selected target equipment action input, a predetermined target equipment action input, a selected target wearer action input, a predetermined target wearer action input, a selected sport type input, a predetermined sport type input, a selected equipment item type input, a predetermined equipment item type input, a selected target improvement goal input, a predetermined target improvement goal input, a reference player selection input, a predetermined reference player input, a selected target outcome input, and/or a predetermined target outcome input and/or any combination(s) thereof.

The control computation unit 141 may be operable to store the input reference data in the datastore 143 and/or in the control memory unit 142. The control computation unit 141 may be operable to define at least a portion of the reference data with the input reference data and/or the input signal. The control computation unit 141 may be operable to index at least a portion of the input reference data with the reference data.

The control system 140 and/or the control computation unit 141 may be operable to perform a determination process based on the equipment signal, the monitor signal, the reference data, and/or the input reference data to generate at least one action set. The action set may be associated with one or more performance phases. The performance phases may comprise one or more of a pocket phase, a transition phase, a separation phase, a recovery phase, a setup phase, a motion phase, and a release phase. The pocket phase, the transition phase, the separation phase, and/or the recovery phase may collectively, alternatively, individually, and/or in any combination(s) thereof, be referred to herein as phase(s) of play. The setup phase, the motion phase, and/or the release phase may collectively, alternatively, individually, and/or in any combination(s) thereof, be referred to herein as “Daily-Hawk Model phase(s).”

The action set(s) may include one or more of an equipment item action set and/or a wearer action set. The equipment item action set(s) may include one or more of an equipment item strain, an equipment item force, an equipment item grip, an equipment item touch, an equipment item acceleration, an equipment item altitude, an equipment item orientation, an equipment item inertia, an equipment item position, an equipment item temperature, an equipment item pressure, an equipment item speed, an equipment item vector, and/or an equipment item travel path. The wearer action set(s) may include one or more of a wearer force, a wearer acceleration, a wearer altitude, a wearer orientation, wearer inertia, a wearer position, a wearer speed, and/or a wearer vector, which may be associated with at least one of a head of the wearer, a shoulder of the wearer, a chest of the wearer, an elbow of the wearer, an abdomen of the wearer, a hip of the wearer, a knee of the wearer, an ankle of the wearer, and/or a foot of the wearer.

The control system 140 and/or the control computation unit 141 may be operable to store the action set(s) in the datastore 143 and/or in the control memory unit 142. The control system 140 and/or the control computation unit 141 may be operable to index the action set(s) with one or more other action set(s) stored in the datastore 143 based on one or more of the equipment action set(s), the wearer action set(s), and/or the performance phase(s) which may be respectively associated with each one of the action set(s). The control computation unit 141 may be operable to generate and send a report output based on one or more of the action set(s) to be displayed on the display 148.

The datastore 143 may include a library of action sets. The library of action sets may be accessible by the control computation unit 141. The library of action sets may include one or more action sets which may be associated with the wearer 101. The library of action sets may further and/or alternatively include one or more actions sets that are not associated with the wearer 101 and may be associated with another wearer 101, such as, and without limitation, a prior wearer 101 and/or a reference wearer 101, a reference player, an example wearer 101, and/or an example player. For the purposes of the present description of the present invention, a prior wearer 101, a reference wearer 101, a reference player, an example wearer 101, and/or an example player may alternatively and/or interchangeably referred to as, either collectively, individually, and/or in any combination(s) thereof, a “non-wearer 101” and/or a “historical reference” without limitation. The action sets associated with the wearer 101 may be defined by each of the action set(s) determined and/or stored by the control computation unit 141 based on monitor signals received by the control computation unit 141 from the monitor system 110 previously and/or currently worn and/or carried by the wearer 101.

In some embodiments of the present invention, the control computation unit 141 may be operable to perform a comparison process to generate a comparison output. The control computation unit 141 may be operable to perform the comparison process to generate the comparison output by comparing one or more of the action set(s) with at least a portion of the library of action sets and/or with at least a predetermined portion of the library of action sets. The comparison output may comprise one or more of a comparison information point that may relate to one or more of the action set(s) and/or performance phase(s). The control computation unit 141 may be operable to send the comparison output to be displayed by the display 148. In some embodiments of the present invention, one or more portion(s) of the library of action sets may comprise a predetermined library of action sets and/or a selected library of action sets that may relate to action set(s) associated with one or more prior wearer(s) 101 and/or reference player profiles having associated player attributes and/or player characteristics.

In some embodiments of the present invention, one or more of the equipment sensor(s) 111-120 comprise a thin-film pressure sensor, a force-sensitive resistor, a capacitive touch sensor, and/or an impact-resistant sensor. The equipment communication unit 205, the monitor communication unit 133, and/or the control communication unit 145 may comprise a wireless communication device as may be understood by those who may have skill in the art. One or more portions of the equipment system 104 and/or the monitor system 110 may have a predetermined rigidity, a predetermined flexibility, and/or impact protection means such that the equipment system 104 and/or the monitor system 110 may have impact-resistant characteristics. In some embodiments of the present invention, the equipment system 104 and/or the monitor system 110 may be water-resistant, humidity resistant, heat resistant, and/or vibration resistant such that the equipment system 104 and/or the monitor system 110 may be significantly unchanged and/or undamaged while and/or after being significantly subjected to and/or exposed to water, humidity, heat, and/or vibrations.

In some embodiments of the present invention, the equipment item 103 may have predetermined performance attributes. The predetermined performance attributes of the equipment item 103 may comprise one or more of a weight, a size, a density, a volume, a volumetric displacement, a surface area, a flexibility, a mass, an air resistance, a quality, a brand type, a manufacturer type, a wear amount, and/or an equipment item type. Each portion of the equipment system 104 may be configured to carried by the equipment item 103 such that one or more the performance attributes of the equipment item 103 before carrying the equipment system 104 may be significantly unchanged in comparison to the performance attributes of the equipment item 103 while the equipment item 103 is carrying the equipment system 104.

The control computation unit 141 may be operable to determine and/or generate one or more of a metric quantification based on one or more of the equipment signal(s), the monitor signal(s), the action set(s), the reference data, the input reference data, and/or the performance phase(s) and/or any combination(s) thereof. The metric quantification(s) may comprise, without limitation, one or more of a release point, a shot power quantification, a guide hand influence factor, a grip pattern classification, performance metric data, a shot classification, a success prediction, a positioning metric, a controlled force application metric, an improved energy transfer metric, at least one flight path metric, an equipment item separation metric, an equipment item release timing metric, a biomechanical alignment, a balance distribution, a wearer body segment relationship, a setup consistency pattern, a movement flow dynamic, a phase transitioning, a rhythm and timing sequence, a shot coordination metric, a coordination pattern, a follow-through metric, a completion pattern, a recovery positioning, a release angle metric, an ideal benchmark metric, a progression metric, a fatigue influence metric, an injury prevention metric, a historical matchup dataset, and/or a team performance metric.

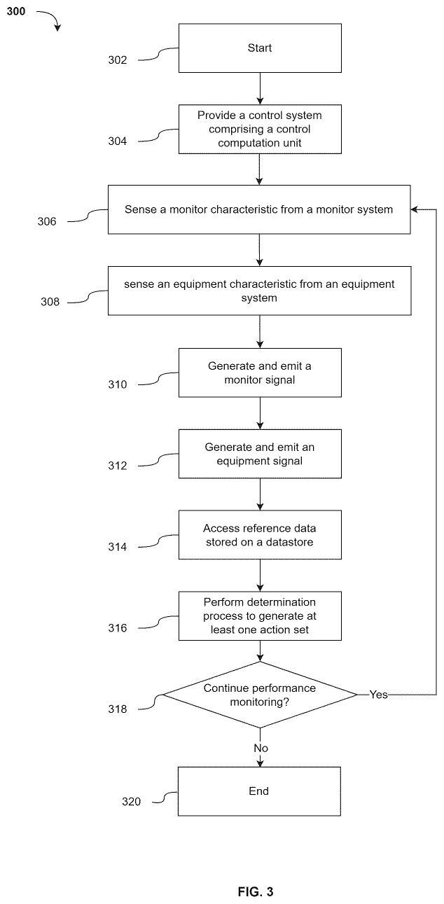

FIG. 3 illustrates a flowchart of a method 300 for performance monitoring according to various embodiments of the present invention. The method 300 provides a systematic approach for monitoring athletic performance by continuously collecting data from both the wearer 101 and the equipment item 103, processing this data through a determination process, and generating actionable insights in the form of action sets. The method 300 begins at start step 302. At step 304, a control system 140 comprising a control computation unit 141 may be provided. At step 306, at least one monitor characteristic is sensed from a monitor system 110 that may be carried by a wearer 101 to define a sensed at least one monitor characteristic, where the at least one monitor characteristic may be sensed by one or more of the monitor sensors 111-120.

At step 308, at least one equipment characteristic may be received and sensed from an equipment system 104 carried by an equipment item 103 to define a sensed at least one equipment item characteristic, where the at least one equipment characteristic may be sensed by the equipment sensor 201. At step 310 a monitor signal associated with the sensed at least one monitor characteristic by the monitor system 110 may be sensed and generated. At step 312, an equipment signal may be generated and emitted by the equipment system 104, where the equipment signal may be associated with the sensed at least one equipment item characteristic. At step 314 reference data may be accessed from a datastore 143 by the control computation unit 141.

At step 316, a determination process may be performed to generate at least one action set by the control computation unit 141 based on one or more of the monitor signal, the equipment signal, and the reference data. At decision step 318, it may be determined whether to continue performance monitoring. If the decision is “Yes,” the method 300 returns to step 306, creating a loop that may allow for continuous monitoring and analysis of the wearer's 101 performance. If the decision is “No,” the method 300 proceeds to step 320, where the process may end. The iterative nature of the method 300 may allow for real-time performance monitoring and analysis, which may be beneficial for athletic training and performance improvement applications.

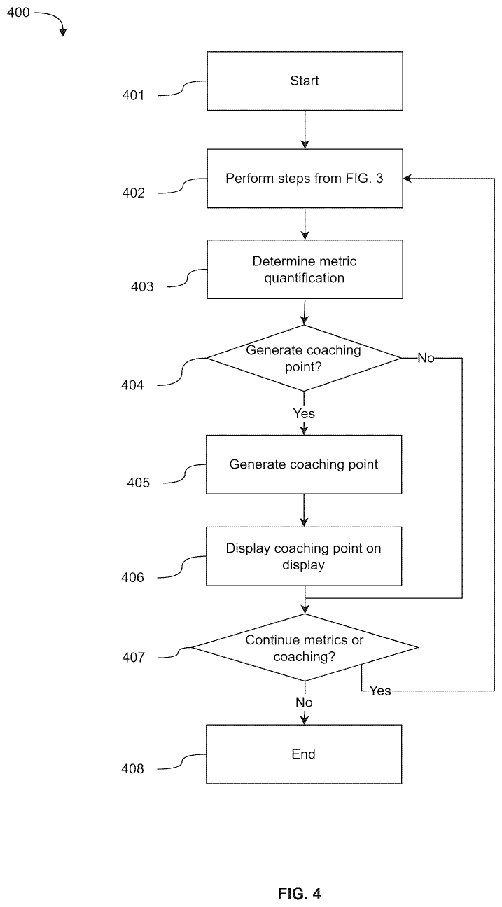

FIG. 4 illustrates a flowchart of a method 400 for performance monitoring with metric quantification and coaching point generation according to various embodiments. The method 400 provides an enhanced approach for performance monitoring by incorporating metric quantification and coaching feedback to support athletic training and performance improvement applications. The method 400 begins at start step 401. At step 402, steps from the method 300 of FIG. 3 may be performed. At decision step 403, it may be determined whether to determine metric quantification.

If the decision is “Yes,” the method 400 proceeds to step 404, where metric quantification may be determined by the control computation unit 141 based on one or more of the monitor signal, the equipment signal, the reference data, and the action sets. If the decision at step 403 is “No,” the method 400 moves directly to decision step 409. At decision step 405, it may be determined whether to generate a coaching point. If the decision is “Yes,” the method 400 proceeds to step 406, where a coaching point may be generated by the control computation unit 141 based on the metric quantification, where the coaching point may include a prompt associated with one or more of a direction, a point of information, a tip, advice, a task, a change, and an improvement related to the action sets. At decision step 407, it may be determined whether to display the coaching point.

If the decision is “Yes,” the method 400 advances to step 408, where the coaching point may be displayed on a display 148 in communication with the control computation unit 141, where the prompt may include a request for input to acknowledge the prompt and the coaching points. At decision step 409, it may be determined whether to continue metrics or coaching. If the decision is “Yes,” the method 400 returns to step 403, creating a loop that may allow for continuous metric quantification and coaching point generation. If the decision is “No,” the method 400 proceeds to step 410, where the process may end.

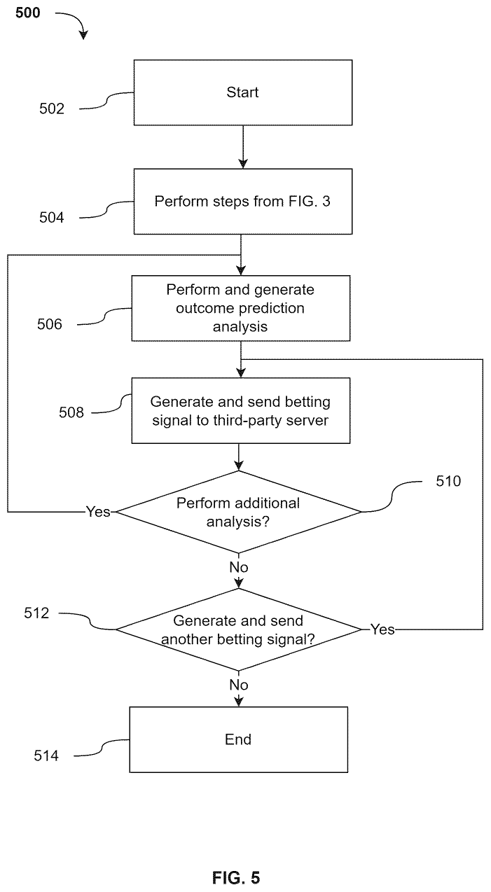

FIG. 5 illustrates a flowchart of a method 500 for performance monitoring with outcome prediction analysis and sports betting integration according to various embodiments. The method 500 provides an advanced approach for performance monitoring by incorporating predictive analysis capabilities and sports betting integration to leverage athletic performance data for wagering applications. The method 500 begins at start step 502. At step 504, steps from the method 300 of FIG. 3 may be performed. At decision step 506, it may be determined whether to generate outcome prediction analysis. If the decision is “Yes,” the method 500 proceeds to step 508, where outcome prediction analysis may be performed and generated by the control computation unit 141 based on one or more of the action sets, the monitor signal, the equipment signal, and historical data stored on the datastore 143.

At decision step 510, it may be determined whether to generate and send a betting signal. If the decision is “Yes,” the method 500 proceeds to step 512, where a betting signal may be generated and sent to a third-party server 197 by the control computation unit 141 based on the outcome prediction analysis, where the betting signal may cause the third-party server 197 to generate an additional sport betting activity or change one or more of the sports betting activities. If the decision at step 506 is “No,” the method 500 may also proceed directly to step 512. At decision step 514, it may be determined whether to perform additional analysis. If the decision is “Yes,” the method 500 returns to step 508, creating a loop for continuous outcome prediction analysis.

If the decision is “No,” the method 500 advances to decision step 516, where it may be determined whether to generate and send another betting signal. If the decision at step 516 is “Yes,” the method 500 returns to step 512 for additional betting signal generation. If the decision is “No,” the method 500 proceeds to step 518, where the process may end.

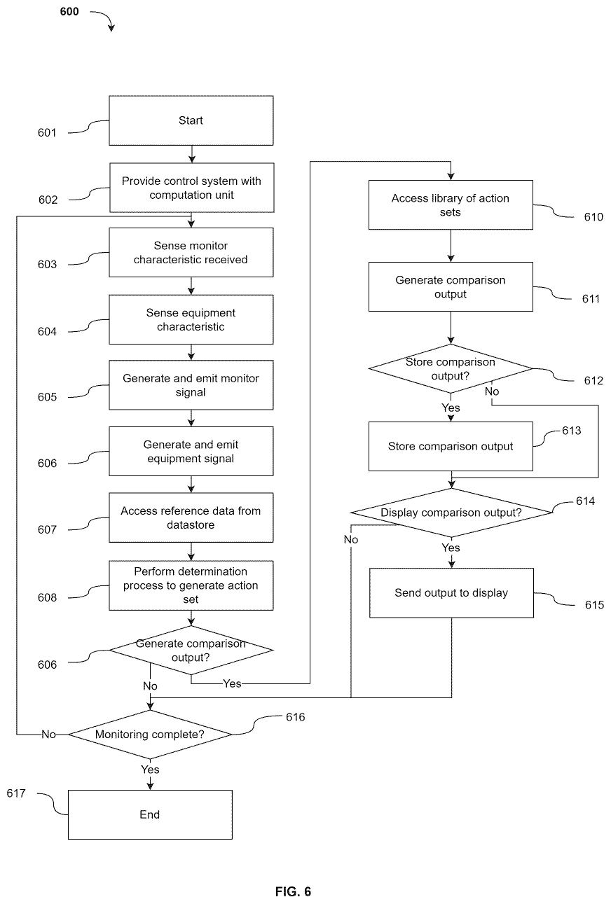

FIG. 6 illustrates a flowchart of a method 600 for basic performance monitoring according to various embodiments. The method 600 provides a streamlined approach for basic performance monitoring without the additional complexity of iterative loops or advanced features. The method 600 begins at start step 602. At step 604, a control system 140 with a control computation unit 141 may be provided. At step 606 a monitor characteristic may be sensed from a monitor system 110 carried by a wearer 101. At step 608, an equipment characteristic may be sensed from an equipment system 104 carried by an equipment item 103.

At step 610 a monitor signal associated with the sensed monitor characteristic by the monitor system 110 is generated and emitted. At step 612, an equipment signal may be generated and emitted by the equipment system 104, where the equipment signal may be associated with the sensed equipment characteristic. At step 614 reference data from a datastore 143 may be accessed by the control computation unit 141. At step 616, a determination process may be performed to generate an action set by the control computation unit 141 based on one or more of the monitor signal, the equipment signal, and the reference data. The method 600 concludes at end step 618.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof.

Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Thus, the scope of the invention should be determined by the appended claims and their legal equivalents, and not by the examples given.

What is claimed is:

1. A system for performance monitoring comprising:
a monitor system configured to be worn by a wearer and operable to monitor and sense at least one monitor characteristic associated with the wearer, to define a sensed at least one monitor characteristic;
an equipment system carried by an equipment item and operable to monitor and sense at least one equipment characteristic associated with the equipment item, to define a sensed at least one equipment characteristic;
a control system that comprises a control computation unit positioned in communication with the monitor system and the equipment system; and
a datastore accessible by the control computation unit;
wherein the monitor system is operable to generate and emit a monitor signal associated with the sensed at least one monitor characteristic;
wherein the equipment system is operable to generate and emit an equipment signal associated with the sensed at least one equipment characteristic; and
wherein the control computation unit is operable to perform a determination process based on at least one of the monitor signal and the equipment signal to generate at least one action set.

2. The system according to claim 1, wherein the control computation unit is further operable to generate a report output based on the at least one action set;
wherein the control computation unit is operable to store the report output; and wherein the control computation unit is operable to send the report output to be displayed on a display in communication with the control computation unit.

3. The system according to claim 1, wherein reference data is stored on the datastore; and wherein the determination process is performed based on at least one of the monitor signal, the equipment signal, and the reference data.

4. The system according to claim 3, further comprising an interface in communication with the control computation unit and operable to provide an input signal responsive to a user input; wherein the input signal comprises input reference data; and wherein the control computation unit is operable to define at least a portion of the reference data based on the input reference data.

5. The system according to claim 1, wherein a library of action sets is stored on the datastore; wherein the control computation unit is operable to generate a comparison output by comparing the at least one action set with at least a portion of the library of action sets; wherein the control computation unit is operable to store the comparison output; and wherein the control computation unit is operable to send the comparison output to be displayed on a display in communication with the control computation unit.

6. The system according to claim 1, wherein the control computation unit is operable to generate at least one metric quantification based on at least one of the monitor signal, the equipment signal, and the at least one action set; wherein the control computation unit is operable to generate at least one coaching point based on the at least one metric quantification; and wherein the control computation unit is operable to send the at least one coaching point to be displayed on a display in communication with the control computation unit.

7. The system according to claim 6, wherein the at least one coaching point includes a prompt associated with at least one of a direction, a point of information, a tip, advice, a task, a change, and an improvement, related to the at least one action set.

8. The system according to claim 7, wherein the prompt includes a request for input to acknowledge the prompt and the at least one coaching point.

9. The system according to claim 1, further comprising an auxiliary sensor system in communication with the control computation unit; wherein the auxiliary sensor system is operable to track and sense at least one auxiliary characteristic associated with at least one of the equipment item and the wearer to be defined as a sensed at least one auxiliary characteristic; wherein the auxiliary sensor system is operable to generate and send an auxiliary signal to the control computation unit based on the at least one sensed auxiliary characteristic; and wherein the determination process is performed based on at least one of the equipment signal, the monitor signal, and the auxiliary signal.

10. The system according to claim 1, wherein the control computation unit is operable to generate an outcome prediction analysis based on at least one of the at least one action set, the monitor signal, and the equipment signal.

11. The system according to claim 10, wherein the control computation unit is further operable to communicate with a third-party server that comprises a sports betting service hosting sports betting activities; and wherein the control computation unit is operable to generate and send a betting signal to the third-party server based on the outcome prediction analysis to cause the third-party server to at least one of generate an additional sport betting activity and change at least one of the sports betting activities.

12. The system according to claim 11, wherein the control computation unit is operable to receive an input signal from an interface; wherein the betting signal is further based on the input signal; and wherein the input signal comprises at least one of a bankroll management rule, an injury report, a hedging threshold, a loss mitigation rule, a multi-position rule, an exit point rule, a cash out timing rule, a closing line value rule, a risk exposure limit rule, a position adjustment rule, and a loss limit rule.

13. The system according to claim 10, wherein historical data is stored on the datastore; and wherein the control computation unit is operable to generate the outcome prediction analysis based on at least one of the at least one action set, the monitor signal, the equipment signal, and the historical data.

14. A control system to be used in connection with a system for performance monitoring, the control system comprising:
a control computation unit operable to communicate with a third-party server;
wherein the third-party server comprises a sports betting service that hosts sports betting activities;
wherein the control computation unit is in communication with a datastore;
wherein the datastore contains reference data and historical data;
wherein the control computation unit is in communication with an auxiliary sensor system;
wherein the auxiliary sensor system is operable to track and sense at least one of an equipment item and a reference player to generate and send an auxiliary signal to the control computation unit;
wherein the control computation unit is operable to perform a determination process based on at least one of the reference data, the historical data, and the auxiliary signal to generate at least one action set;
wherein the control computation unit is operable to generate an outcome prediction analysis based on at least one of the reference data, the historical data, the auxiliary signal, and the at least one action set; and
wherein the control computation unit is operable to send a betting signal to the third-party server based on the outcome prediction analysis to cause the third-party server to at least one of generate and change at least one sport betting activity.

15. The control system according to claim 14, wherein:
the system for performance monitoring comprises a monitor system and an equipment system;
the monitor system is in communication with the control computation unit and is configured to be worn by the reference player to define a wearer;
the monitor system is operable to monitor and sense at least one monitor characteristic associated with the wearer to define a sensed at least one monitor characteristic;
the monitor system is operable to generate and emit a monitor signal associated with the sensed at least one monitor characteristic;
the equipment system is in communication with the control computation unit and is configured to monitor and sense at least one equipment item characteristic associated with the equipment item to define a sensed at least one equipment item characteristic;
the equipment system is operable to generate and emit an equipment signal associated with the sensed at least one equipment item characteristic;
the determination process is performed based on at least one of the reference data, the historical data, the auxiliary signal, the monitor signal, and the equipment signal; and
the outcome prediction analysis is performed based on at least one of the reference data, the historical data, the auxiliary signal, the at least one action set, the monitor signal, and the equipment signal.

16. The control system according to claim 14, wherein the control computation unit is operable to receive an input signal from an interface in communication with the control computation unit; wherein the betting signal is further based on the input signal; and wherein the input signal comprises at least one of a bankroll management rule, an injury report, a hedging threshold, a loss mitigation rule, a multi-position rule, an exit point rule, a cash out timing rule, a closing line value rule, a risk exposure limit rule, a position adjustment rule, and a loss limit rule.

17. The control system according to claim 14, wherein the control computation unit is operable to receive an input signal from an interface that is in communication with the control computation unit; wherein the input signal comprises input reference data; and wherein the control computation unit is operable to define at least a portion of the reference data based on the input reference data.

18. A method for performance monitoring comprising:
providing a control system comprising a control computation unit;
sensing at least one monitor characteristic received from a monitor system that is carried by the wearer to define a sensed at least one monitor characteristic;
sensing at least one equipment characteristic received from equipment item with an equipment system that is carried by the equipment item to define a sensed at least one equipment item characteristic;
generating and emitting a monitor signal associated with the sensed at least one monitor characteristic;
generating and emitting an equipment signal associated with the sensed at least one equipment item characteristic;
accessing reference data stored on a datastore with the control computation unit; and
performing a determination process based on at least one of the monitor signal, the equipment signal, and the reference data to generate at least one action set.

19. The method according to claim 18, further comprising determining at least one metric quantification based on at least one of the monitor signal, the equipment signal, the reference data, and the at least one action set; generating at least one coaching point based on the at least one metric quantification; and displaying the at least one coaching point on a display in communication with the control computation unit; wherein the at least one coaching point includes a prompt that is associated with the at least one action set; and wherein the prompt comprises at least one of a direction, a point of information, a tip, advice, a task, a change, and an improvement.

20. The method according to claim 18, further comprising performing and generating an outcome prediction analysis based on at least one of the equipment signal, the monitor signal, the reference data, and the at least one action set; and generating and sending a betting signal to a third-party server based on the outcome prediction analysis to cause the third-party server to at least one of generate a sport betting activity and change at least one of a plurality of sports betting activities.
